(19) United States
(12) Patent Application Publication
(10) Pub. No.: US 2007/0124881 A1
(43) Pub. Date: Jun. 7, 2007

(54) COMBINATION PAINTER KNIFE AND PUTTY STORAGE CONTAINER

(76) Inventor: Darren Daugherty, Harned, KY (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/560,117

(22) Filed: Nov. 15, 2006

Related U.S. Application Data
(60) Provisional application No. 60/742,385, filed on Dec. 5, 2005.

(51) Int. Cl. B25G 1/08; A47L 13/022

(52) U.S. Cl. 15/143.1; 16/111.1; 15/236.01; 15/236.03

(57) ABSTRACT

A combined painter knife and putty storage container. A pair of shells are movably mounted together enclosing a putty storage container. The container opens along the length of the shells forming a handle to which is fixedly mounted a painter's knife.

### RELATED APPLICATION

This application claims the benefit of U.S. Provisional Patent Application Ser. No. 60/742,385, filed Dec. 5, 2005 which is hereby incorporated by reference.

### BACKGROUND OF THE INVENTION

1. Field of the Invention

The present invention relates generally to the field of knives used by painters and more specifically, those knives having storage containers therein.

2. Description of the Prior Art

Knives used by painters include a sharp straight edge mounted to a handle. The straight edge is used to scrape paint off of various items, such as glass, trim, etc. Frequently, when painting a wall or trim, the painter will encounter nail holes or other imperfections. It is the practice to apply putty or other flowable plastic material to the hole or recess thereby providing an even surface when painted. The various types of flowable materials including caulking and sealing compounds.

Typically, the flowable material is contained in a squeezable container separate from the painter knife. In order to facilitate ease of painting and reducing the time required to paint a surface, it is desirable to combine the flowable material container with the painter knife. Such a combination is disclosed in U.S. Pat. No. 5,800,144 issued to Glenn et al. wherein an applicator-container is disclosed that has an interior cavity to receive the flowable material. A threaded cap at one end is used to open and close the internal cavity whereas the opposite end of the container is tapered to form a blade straight edge. When it is desired to insert or remove the putty or other material from within the container, the threaded cap is removed. The user's finger or tools, such as, a screw driver tip, knife blade or stick is inserted into the cavity to dispense a portion of the flowable material.

It can be appreciated when removing putty from an elongated cavity from one end of the cavity; it becomes difficult to easily remove all of the putty. Disclosed herein is a combination painter knife and a putty storage container formed in the knife handle with the container opening along the entire length of the cavity allowing complete access to the putty. Thus, they putty or other flowable material may be easily inserted and removed from the cavity.

I have further improved the combination knife and storage container by providing an easily opened lid that extends the length of the cavity. The lid enclosing the cavity may be lifted relative to the handle thereby opening the cavity. As a result, the painter when grasping the handle may simply use his or her thumb to remove the lid without requiring a second hand to remove the lid. In many cases, the second hand may already be busy holding a paint brush.

### SUMMARY OF THE INVENTION

A combination painter knife and putty storage container including a rigid frame having a distal end forming a straight knife edge and further having a proximal end. An elongated handle forms a putty storage container with a longitudinally extending axis, a first end portion, and an opposite second end portion and the axis extending therethrough. The handle is fixedly connected to the proximal end of the rigid frame. The handle further has a first shell with spaced apart opposite first edges extending in the direction of the axis, and a second shell with spaced apart opposite second edges that also extend in the direction of the axis. The first edges are in contact with the second edges when the first shell is closed on the second shell. The first shell and the second shell cooperatively form a cavity located between the first edges and the second edges and between the first end portion and the second end portion. A locking means on the first shell and the second shell is operable to releasably hold the first edges against the second edges enclosing the cavity but yieldable to allow at least some of the first edges and the second edges to move apart to allow access to the cavity for insertion and removal of putty.

It is an object of the present invention to provide a new and improved painter knife.

A further object of the present invention is to provide a combined painter knife and flowable material storage container.

Yet a further object of the present invention is to provide a painter knife having putty stored therein which may be removed without requiring two hands.

Related objects and advantages of the present invention will be apparent from the following description.

### BRIEF DESCRIPTION OF THE DRAWINGS

FIG. 1 is a plan view of the painter knife incorporating my present invention.

FIG. 2 is the same view as FIG. 1 only showing the container in the open position.

FIG. 3 is a side view looking in the direction of arrows 3-3 of FIG. 1.

### DESCRIPTION OF THE PREFERRED EMBODIMENT

For the purposes of promoting an understanding of the principles of the invention, reference will now be made to the embodiment illustrated in the drawings and specific language will be used to described the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Referring now more particularly to the drawings, there is shown a combination painter knife and putty storage container 10 having a rigid metal frame 11 fixedly mounted to a plastic handle 12. Rigid frame 11 is formed in accordance with the commercially available painter knife having an elongated shape with a sharp scraping straight edge 13 formed at the distal end thereof. The proximal end 14 is fixedly mounted to handle 12 by being embedded within the plastic handle and secured thereto by rivets or other conventional fastening devices 15.

The elongated handle 12 has an interior storage container 16 formed cooperatively by a pair of shells 17 and 18 hingedly connected together by a conventional living hinge 19. Other means may be used to secure shells 17 and 18 together. For example, the shells can be secured together by any standard means, such as, conventional fastening devices.

Longitudinal axis 20 extends centrally along the length of the blade as well as handle 12. The handle has a first end portion 21 and a second end portion 22 with axis 20 extending centrally therethrough.

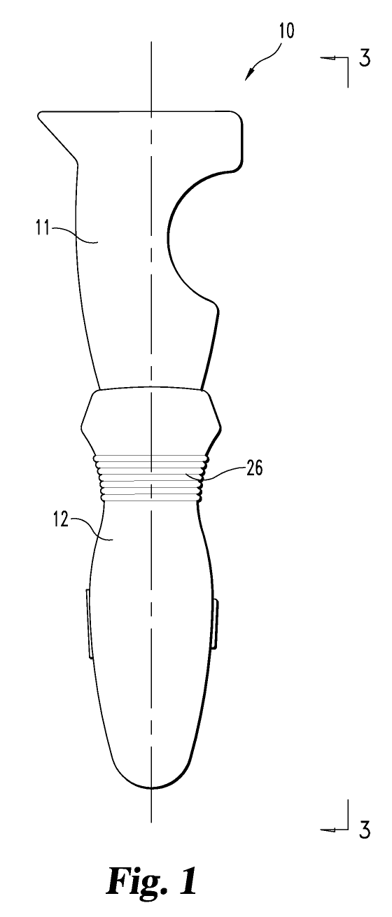

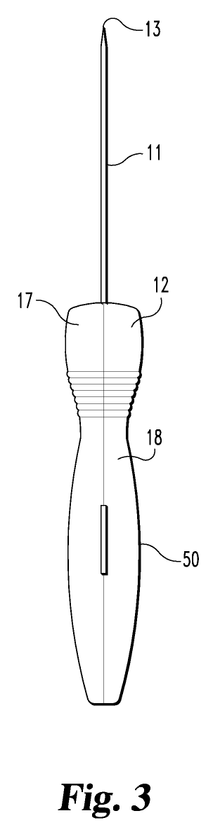

In the embodiment shown in the drawings, shells 17 and 18 are a mirror image of each other with the exception that shell 18 includes an outwardly located ridge 23 that is releasably held by a latch 24 mounted to shell 17. The external geometry of both shells as well as the internal cavity of each are a mirror image of each other. Thus, the peripheral edge of shell 17 makes with the peripheral edge of shell 18 when the two shells are closed atop each other as shown in FIGS. 1 and 3. The end portion 22 of each shell has a reduced or necked down portion 25 to form a gripping area for the thumb of the painter when the painter grasp the handle. A plurality of friction ridges 26 are provided on the outside surface of each shell surrounding the reduced portion 25 to facilitate the gripping thereof.

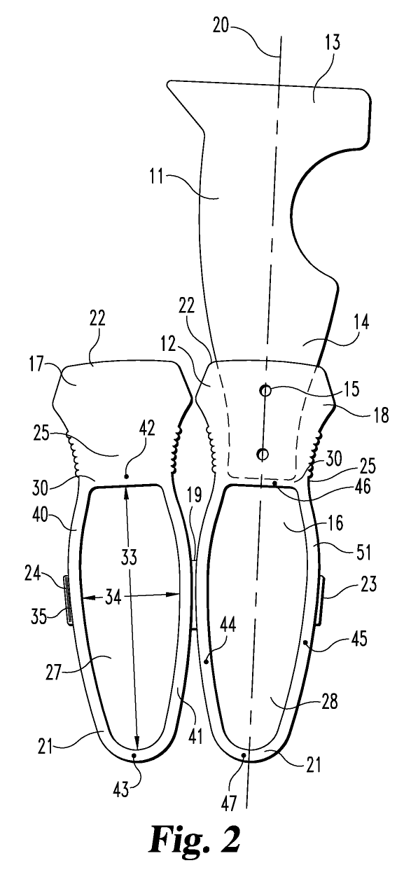

Cavity 16 is used to store flowable material, such as, putty and caulking compound. Cavity 16 is composed of two identically shaped cavities 27 and 28 provided respectively in shells 17 and 18. Cavities 27 and 28 extend from end portion 21 to an intermediate location 30, in turn, located between the opposite end portions 21 and 22 of each shell. Each shell is recessed forming the cavities to cooperatively form cavity 16 for holding the putty or other flowable material. Cavities 27 and 28 each have length 33 that extends in the direction of axis 20 and likewise have width 34 extending perpendicularly across each shell with respect to axis 20. Likewise, hinge 19 extends in the direction of axis 20. By moving shell 17 relative to shell 18 from the closed position depicted in FIGS. 1 and 3 to the open position depicted in FIG. 2, the painter has complete access to the putty or other flowable material located with the cavity along the entire length and width of the cavity. Thus, it is unnecessary to extend a knife or other object into the cavity in order to pull out or force the material from the opposite end of the cavity. In the putty container shown in the drawings, complete access to the cavity is accomplished since shall 17 is moved so that cavities 27 and 28 are separated.

Rigid frame 11 extends, in the embodiment shown in the drawings, into shell 18 and may be positioned therein when the shell is initially formed. Alternatively, a rectangular recess may be formed in shell 18 with a complementary shaped proximal end of the rigid frame inserted therein and held thereto by fastening devices 15. The proximal end 14 of the rigid frame does not extend into cavity 16 and terminates at the intermediate location 30. In the event rigid frame 11 is embedded into shell 18 so that shell 18 extends completely around proximal end 14, then ends 22 of shells 17 and 18 are in contact across the entire width of the handle from intermediate location 30 to end 22 as well as along the length of the same portion from end 22 to intermediate location 30.

A locking means is provided on the pair of shells and may include an outwardly projecting ridge 23 that is releasably held by an elastic cantileverly mounted arm 24 having a recess 35 complementary in shape to ridge 23. Thus, when closing the shells together, latch 24 elastically moves over ridge 23 until the ridge is within recess 35 thereby holding the shells together. In order to open the shells and expose the complete cavity, latch 24 is pried away from ridge 23 and the shells are moved apart.

Surrounding each cavity 27 and 28 is a circumferentially extending edge portion for each shell. That is, shell 17 includes portions 40, 41, 42 and 43 forming edge portions surrounding cavity 27 that mate with similar edge portions respectively 44-47 of shell 18 when the shells are in the closed position and latch 24 is releasably engaged with ridge 23. Peripheral edge portions 40 and 41 of shell 17 as well as peripheral edge portions 44 and 45 of shell 18 extend generally in the direction of axis 20 when the shells are closed. The peripheral edge portions of one shell are in contact with the peripheral edge portions of the second shell when closed preventing the material within the cavity from flowing outward.

Shell 18 (FIG. 3) has a first side 50 that is closed at all times whereas the opposite side 51 (FIG. 2) has cavity 28 extending therethrough. Thus, side 51 is open when shell 17 forming the lid is closed on shell 18. Cavity 28 is formed between the opposite sides 50 and 51 of shell 18.

The painter knife disclosed herein enables the painter to always have putty on his or her person at all times. Experience in the painting field shows that when painting trim work in homes or businesses, the painter always runs across several nail holes that have been overlooked, and the painter either does not have putty at the particular time or has left the putty in another room or place where they were previously utilized. With the device disclosed herein, the painter will always have a five-way painter knife but will also have putty readily available at the same time saving money as well as increasing productively and eliminating the aggravation of looking for putty. The storage container will ensure long lasting storage of the putty until it is needed to be refilled or replaced.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A combination painter knife and putty storage container comprising:
a rigid frame having a distal end forming a straight edge and further having a proximal end;
a elongated handle forming a putty storage container with a longitudinally extending axis and having a first end portion and an opposite second end portion with said axis extending therethrough, said handle fixedly connected to said proximal end of said rigid frame, said handle further having a first shell with spaced apart opposite first edges extending in the direction of said axis and a second shell with spaced apart opposite second edges extending in the direction of said axis, said first edges being in contact with said second edges when said first shell is closed on said second shell, said first shell and said second shell cooperatively forming a cavity located between said first edges and said second edges and between said first end portion and said second end portion; and,
locking means on said first shell and said second shell operable to releasable hold said first edges against said second edges enclosing said cavity but yieldable to allow at least some of said first edges and said second edges to move apart to allow access to said cavity for insertion and removal of putty.

2. The combination of claim 1 and further comprising:
a hinge connected to said first shell and said second shell with said hinge extending in the direction of said axis.

3. The combination of claim 2 wherein:
said hinge is a living hinge integrally connected to said first shell and said second shell.

4. The combination of claim 2 wherein:
said locking means includes a projection on said first shell and an elastic portion complementary to said projection on said second shell to releasable engage said projection.

5. The combination of claim 4 wherein:
said first shell and said second shell are recessed to cooperatively form said cavity.

6. The combination of claim 1 wherein:
said cavity has length extending along said axis with said cavity completely open along said length when said first edges are apart form said second edges allowing complete access to said cavity along said length.

7. The combination of claim 1 wherein said rigid frame is metal and said handle is plastic and further comprising a fastener securing said rigid frame to said handle.

8. The combination of claim 1 wherein said cavity extends from said second end portion to an intermediate location between said first end portion and said second end portion, said proximal end portion of said rigid frame secured to said handle at a location between said first end portion and said intermediate location, said first shell and said second shell have width and are in contact with each other entirely along said width between said intermediate location and said first end portion limiting flow of putty therebetween.

9. A painter knife comprising:
a rigid frame having a distal end forming a straight knife edge and further having a proximal end;
a elongated handle forming a flowable material storage container with a longitudinally extending axis and having a first end portion and an opposite second end portion with said axis extending therethrough, said handle fixedly connected to said proximal end of said rigid frame, said handle further having a first shell with spaced apart opposite first edges extending in the direction of said axis and a second shell with spaced apart opposite second edges extending in the direction of said axis, said first edges being in contact with said second edges when said first shell is closed on said second shell, said first shell and said second shell cooperatively are recessed forming a cavity located between said first edges and said second edges and between said first end portion and said second end portion, said cavity has length extending along said axis with said cavity completely open along said length when said first edges are apart form said second edges allowing complete access to said cavity along said length;
a hinge connected to said first shell and said second shell with said hinge extending in the direction of said axis; and,
a lock on said first shell and said second shell releasable holding said first edges against said second edges enclosing said cavity and yieldable to allow at least some of said first edges and said second edges to move apart to allow access to said cavity for insertion and removal of flowable material; and wherein:
said cavity extends from said second end portion to an intermediate location between said first end portion and said second end portion, said proximal end portion of said rigid frame secured to said handle at a location between said first end portion and said intermediate location, said first shell and said second shell have width and are in contact with each other entirely along said width between said intermediate location and said first end portion limiting flow of flowable material therebetween.

10. A painter knife:
a rigid knife with a proximal end;
a handle fixedly attached to said proximal end and having a putty cavity formed therein, said handle has a first side extending along said axis and further having a lid mounted thereto being movable from a closed position whereat said cavity is closed to an open position wherein said cavity is open to allow access thereto, said handle has a longitudinally extending axis with said cavity opening along said axis and allowing insertion and removal of putty though said side; and,
a lock on said handle to hold said lid in said closed position but releasable to allow said lid to move to said open position.

11. The knife of claim 10 wherein:
said handle has a second side opposite of said first side, said second side is closed whereas said first side has an opening that is open when said lid is in said open position, said cavity is located between said first side and said second side.

12. The knife of claim 11 wherein:
said opening extends along the entire width and length of said cavity allowing complete access to said cavity when said lid is open.

13. The knife of claim 12 wherein:
said handle has a first end and opposite second end with said axis extending therebetween, said cavity extends from said second end to an intermediate location between said first end and said second end.

14. The combination of claim 13 and further comprising:
a hinge mounting said lid with said hinge extending in the direction of said axis.

15. The combination of claim 14 wherein:
said hinge is a living hinge integrally connected to said handle.
